(19) United States
(12) Patent Application Publication
(10) Pub. No.: US 2009/0123614 A1
(43) Pub. Date: May 14, 2009

(54) PACKAGING WHICH IS SUITABLE FOR MICROWAVES

(75) Inventors: Walter Bernig, Rettenberg (DE); Bernard Dujardin, Brussel (BE); Jorg Feisel, Biedenkopf (DE)

Correspondence Address: NORRIS, MCLAUGHLIN & MARCUS, P.A., 875 THIRD AVE, 18TH FLOOR, NEW YORK, NY, 10022, US

(73) Assignee: CFS KEMPTEN GMBH, Kempten (DE)

(21) Appl. No.: 12/296,723

(22) PCT Filed: Apr. 11, 2007
(86) PCT No.: PCT/EP2007/003209

§ 371 Date: Jan. 22, 2009

(30) Foreign Application Priority Data
Apr. 13, 2006 (DE) 10 2006 017 834.3

(51) Int. Cl. B65D 81/34; A23L 1/025

(52) U.S. Cl. 426/107; 426/234; 220/366.1; 426/118

(57) ABSTRACT

A packaging suitable for microwaves and made of plastic film, having a packaging recess in which a packaged product is introduced, and of a closing film which is sealed on a margin of the packaging recess along a sealing seam, the margin having a region which is formed as a duct and is initially closed and through which, after opening along a weakening line, steam can escape during the heating of the packaged product. A method for heating the packaged product in the packaging is also disclosed.

The present invention relates to a packaging suitable for microwaves and consisting of a preferably thermoformed packaging recess, in which a packaged product is present, and of a film closing the packaging recess, preferably a lid film, which is sealed onto the margin of the packaging recess along a sealing seam, the sealing seam having a region through which steam can escape when the packaged product is heated preferably with the aid of microwaves. The present invention relates, furthermore, to a method for heating the packaged product in the packaging according to the invention.

Packaged products, in particular foodstuffs, are often offered in packagings consisting of thermoplastics. These packagings are produced, inter alia, from plastic films and may consist of a thermoformed, for example deep-drawn, packaging recess, into which the packaged product is introduced, and of a lid film by means of which the packaging recess is closed so as to be gastight. For this purpose, in most instances, the lid film is sealed onto the packaging recess, preferably after gas exchange or an evacuation of the packaging. The lid film may likewise be thermoformed. In packagings of this type, foods, such as ready meals, which have to be heated before consumption, are also often introduced. This heating may take place, for example, in the packaging in a microwave oven. Since, during heating, particularly the final stage of heating, steam often arises, this steam has to be discharged so as to avoid an uncontrolled bursting of the packaging.

There have therefore been many attempts to make available packagings suitable for microwaves which are suitable for heating by means of microwaves. For example, WO03/020680 A1 discloses a packaging which is beatable in a microwave oven and from which steam can escape during heating, since the sealing seam, by virtue of its tear-open strength, is configured to be peelable in a relatively narrow region which is not to be overshot. This requires high production accuracy in order to prevent an overshooting of the strength limits and, consequently, an unwanted bursting because the packaging is not opened, this production accuracy being possible only at the expense of the production rate.

The object of the present invention, therefore, was to make available a packaging which is suitable for microwave heating and in which the packaged product can be heated in the essentially closed packaging with the aid of microwaves, without the risk of bursting and without the production rate in the production of the packaging being impaired.

This object is achieved by the provision of the packaging according to the invention, suitable for microwaves, consisting of a packaging recess in which a packaged product is introduced and of a closing film which is sealed onto the peripheral margin of the packaging recess along a sealing seam, the margin of the packaging recess having a region through which steam can escape during the heating of a packaged product, which packaging is characterized in that both the packing recess and the closing film consist essentially of thermoplastic material suitable for microwaves, and the margin of the packaging recess has in the region a duct which extends from the inner boundary of the margin of the packaging recess as far as the inner boundary of the sealing seam and is initially closed outwardly by means of the adjacent sealing seam and is to be opened mechanically, only before heating, along a weakening line in the margin of the packaging recess, with the result that steam can escape during the heating of the packaged product.

With the aid of the packaging according to the invention, it is possible to heat packaged product easily in a microwave oven, since it is ensured that the packaging according to the invention neither opens in an uncontrolled way nor bursts. Furthermore, the packaging according to the invention can be produced simply and cost-effectively, without the usually high production rate, that is to say packaging rate, having to be reduced.

As already mentioned, the packaging according to the invention consists of a packaging recess which has preferably been formed from a preferably multilayer plastic film sheet, which is known as the underfilm sheet, by thermoforming, preferably by deep-drawing. This plastic film is suitable for microwaves.

According to the present invention, the term “suitable for microwaves” is understood to mean a plastic material which is permeable to microwaves, at least 80% of the microwaves, preferably at least 95% of the microwaves, which are generated in a microwave oven, being permeable through the plastic film. Furthermore, the plastic material should not be deformed or broken down due to the influence of the microwaves. This means that the material suitable for microwaves, as it is known, must withstand heating by microwaves at 121° C. for half an hour without deformation, and at most 60 ppm of contaminating breakdown products should be discharged to the packaged product to be heated, in particular to the packaged food.

Preferably, the preferably multilayer plastic film sheet, which is used as an underfilm sheet comprises at least one outer carrier layer consisting of polyolefin, preferably of polypropylene or polyethylene, such as high-density polyethylene (HDPE), polyester, such as polyethylene terephthalate, or of another thermoplastic which is suitable for microwaves, and, on its other surface, a sealing layer.

The sealing layer material suitable for microwaves which is used is preferably a thermoplastic material which, after sealing by means of the sealing layer of the film closing the packaging recess, what is known as the overfilm sheet, has a sealing strength of preferably at least 4 N/25.4 mm, measured according to ISO 527-3.

This sealing layer plastic material may preferably be based on a polyolefin such as, for example, a polypropylene, propylene/ethylene copolymer, a polyethylene, most particularly preferably a low-density polyethylene (LOPE) or a linear low-density polyethylene (LLDPE), an m-polyethylene (m-PE) or its mixtures, on a amorphous polyester, such as an amorphous polyethylene terephthalate, on an ionomer and/or on an ethylene/(meth)acrylic acid copolymer. The sealing layer may also be constructed from an ethylene/vinyl acetate copolymer or a blend of polyethylene and polybutylene, a blend of polypropylene and polybutylene or its copolymers as a polymer component. Furthermore, it is also possible that the sealing layer is based on a copolymer of ethylene/butylene or of propylene/butylene.

Preferably, the multilayer plastic film sheet, which is used as an underfilm sheet producing the packaging recess, also contains a gas barrier layer which is characterized, in particular, by low oxygen permeability and consists particularly preferably of vinylidene chloride homopolymer or copolymer, of an ethylene/vinylalcohol copolymer, of a polyamide or of mixtures of at least two of said polymers. In this case, the vinylidene chloride may preferably be copolymerized with an alkyl acrylate or alkyl methacrylate or vinyl chloride.

The packaging recess preferably produced from such a multilayer plastic film sheet by thermoforming is filled with the packaged product which is preferably a liquid, liquid/solid, pasty, solid, frozen and/or heating-liquified food. This food should, of course, also be suitable for microwaves on account of heating by microwaves.

After filling, the packaging recess is closed by means of a closing film, preferably a lid film, consisting of what is known as the overfilm sheet which, if appropriate, may also be thermoformed or heat-shrinkable.

For this purpose, the same type of multilayer plastic film sheet may be used as the overfilm sheet as is also used for producing the packaging recess. Preferably, this multilayer plastic film which is used as a closing film, preferably a lid film, is also equipped with a glass barrier layer based on the above-listed polymers having gas barrier properties.

Furthermore, the closing film also has on one of its surfaces a sealing layer, a sealable polymer component of which preferably corresponds at least to one of the polymer components of the sealing layer of the underfilm. The sealing layer is preferably based on a polyolefin, particularly preferably on a polypropylene, a polyethylene, such as a low-density polyethylene (LDPE), a linear low-density polyethylene (LLDPB), a high-density polyethylene (HDPE), an m-polyethylent (m-PE), an ionomer, an ethylene/vinyl acetate copolymer (EVA) or mixtures of these polymers.

The overfilm sheet may also be stretched monoaxially or biaxially, in particular in order to be heat-shrinkable and, consequently, to shrink as what is known as a skin packaging element around part of the contents and/or the packaging recess. Preferably, the thickness in the sealing layer lies in the range of 1 to 30 μm, preferably in the range of 10 to 20 μm.

The underfilm sheet may have an overall thickness of up to 1800 μm, while the outer carrier layer should amount to at least 60% of the overall thickness of the underfilm sheet.

The thickness of the overfilm sheet used for closing the packaging recess may be identical to the thickness of the underfilm. If preferably has a thickness of up to 400 μm, most particularly preferably a thickness of 20 to 200 μm.

Preferably, at least the overfilm used as a closing film, preferably as a lid film, is transparent.

To close the packaging recess after filling, the overfilm sheet is sealed onto the margin of the packaging recess in the form of a sealing seam, if appropriate after the atmosphere in the packaging has been exchanged for an inert gas, such as N₂, atmosphere or a vacuum has been applied, During sealing, care must be taken to ensure that the sealing strength preferably amounts to at least 4 N/25.4 mm, particularly preferably 6 to 15 N/25.4 mm (according to ISO 527-3).

Moreover, the packaging according to the invention has a region through which the steam possibly occurring during the heating of the packaged product preferably with the aid of microwaves can escape.

For this purpose, the margin of the packaging recess has in a preferably single region, preferably in a corner region, at least one duct which is initially closed outwardly, gastight, by the closing film, preferably the lid film, sealed onto the margin of the packaging, but through which the steam possibly occurring during the heating of the packaged product can escape after the duct has been opened immediately before heating.

Preferably, the duct extends from the inner boundary of the margin of the packaging recess as far as the inner boundary of the sealing seam located on this margin, and it must be ensured that the sealing seam adjacent there still closes the duct outwardly, gastight, before opening immediately before heating. Preferably, the duct of the recess tapers in the direction of the sealing seam, that is to say from the depression of the packaging recess in the direction of the outer boundary of the margin, the adjacent sealing seam at least following and covering the run of the tip of the duct.

Preferably, the duct is located in the marginal region of one corner of the packaging, the tip of the duct being oriented in the direction of the preferably rounded corner of the packaging according to the invention.

To open the duct before heating, for example, in a microwave oven, the packaging according to the invention has a weakening line at least in the region of the duct, preferably transversely to the longitudinal orientation of the duct. Preferably, the weakening line also runs transversely in each case through the adjacent regions of the sealing seam.

The weakening line is preferably arranged in the margin of the packaging recess transversely to the longitudinal direction of the duct as a predetermined breaking and/or predetermined bending point. Preferably, the weakening line is arranged on the underside of the margin. By virtue of this embodiment according to the invention, it is possible to open the duct in this region preferably by mechanical action on the weakening line. Thus, for example, by bending along the weakening line, at least the tip of the duct can be opened, while the steam occurring during the heating of the packaging or of the packaged product can escape through the opening.

The weakening line may run as a straight line only in the region of the duct, only in each case in the regions of the sealing seam adjacent to the duct or continuously from the outer boundary of the margin of the packaging recess transversely through the sealing seam region initially adjacent to the duct, further on transversely over the duct region and transversely through the sealing seam region, again adjacent to the duct, as far as the outer boundary of the margin of the packaging recess.

The weakening line is preferably formed on the underside of the margin of the packaging recess and is identified preferably by a marking, so that the final consumer finds the weakening line without difficulty in order to open the duct.

Preferably, the weakening line is implemented as a predetermined breaking and/or predetermined bending point by means of a reduction in the film thickness. This reduction in the film thickness may take place by means of a partial cut, by punching, by notching and/or by embossing on the devices known to a person skilled in the art, preferably even during the thermoforming of the packaging recess, such that a groove is formed as a weakening line in the packaging recess or on the underside of the margin.

Preferably, the weakening line is designed as a predetermined breaking and/or predetermined bending point such that it also has an indicator function, that is to say a noise occurs during bending. It is thereby clear to the user that, on the one hand, the packaging according to the invention has not yet been opened in this region and, on the other hand, the packaging according to the invention is opened sufficiently for heating, preferably in a microwave oven, in order to cause the steam occurring in this case to escape and so that an uncontrolled bursting of the packaging according to the invention can be avoided reliably.

Preferably, an opening aid, such as, for example, a tab, which is easily accessible, may also be located in the corner region in which the steam can escape through the opening of the duct. This tab can be grasped by the final consumer after the heating of the packaged product and, consequently, the closing film, preferably the lid film, can be released from the packaging recess so that the packaged product can be consumed.

The packaging according to the invention can advantageously be produced on what is known as a forming/filling/sealing packaging machine. In a machine of this type, first the underfilm sheet is preferably heated to the plasticization temperature, and then the packaging recesses are formed into this heated underfilm sheet by thermoforming, such as, for example, deep-drawing. In this case, as mentioned above, preferably even at this stage the weakening line is also formed preferably on the underside of the margin of the packaging recess, and the duct is coformed. This packaging recess thus produced is cooled, if appropriate, and is then filled with the packaged product, in particular with a food. Subsequently, the filled packaging is closed by means of an overfilm sheet as a closing film, preferably as a lid film, the closing film being sealed in a sealing device onto the margin of the packaging recess, if appropriate after an exchange of atmosphere in the packaging or evacuation. The packagings thus produced are finally individually separated, while, if appropriate, before or after individual separation, the closing film may be shrunk in the usual way by heating in order to produce an at least partial skin packaging.

According to the invention, the duct through which the steam is to escape during heating, for example, in a microwave oven may be coformed even during the thermoforming of the underfilm. For this purpose, the deep-drawing die has a corresponding indentation, into which the underfilm sheet is either pressed or drawn. Insofar as the weakening line is not also already coformed in this case, the latter may preferably be incorporated into the underside of the packaging margin after the sealing of the packagings by a mechanical action on suitable devices.

A further subject of the present invention is also a method for heating a packaged product in a packaging according to the invention, according to which the sealed packaging is bent along its weakening line in order to open the duct before heating and the packaging is then heated preferably in a microwave oven with the aid of microwaves, while the steam occurring can escape through the opened duct.

By means of the method according to the invention, it is possible to rule out the risk of an uncontrolled bursting of the packaging during heating, since, because the duct is opened before heating, an uncontrolled pressure rise due to the generation of steam within the packaging is avoided.

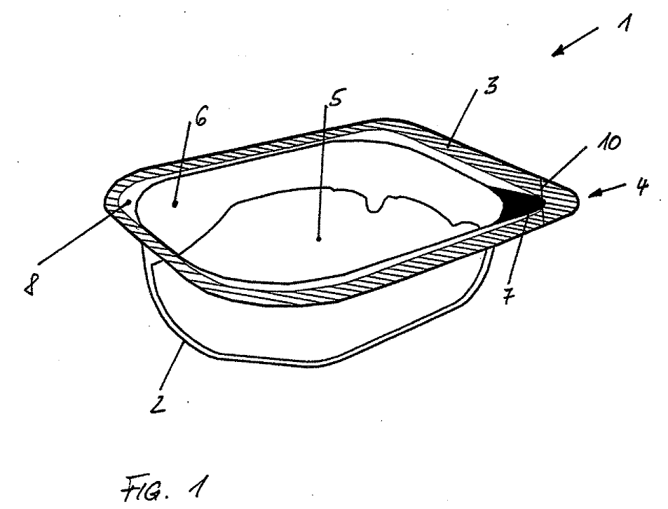

The present invention is explained below with reference to FIGS. 1-4. These explanations are merely by way of example and do not restrict the general idea of the invention. The explanations apply equally to all subjects of the invention.

FIG. 1 shows the packaging according to the invention before heating.

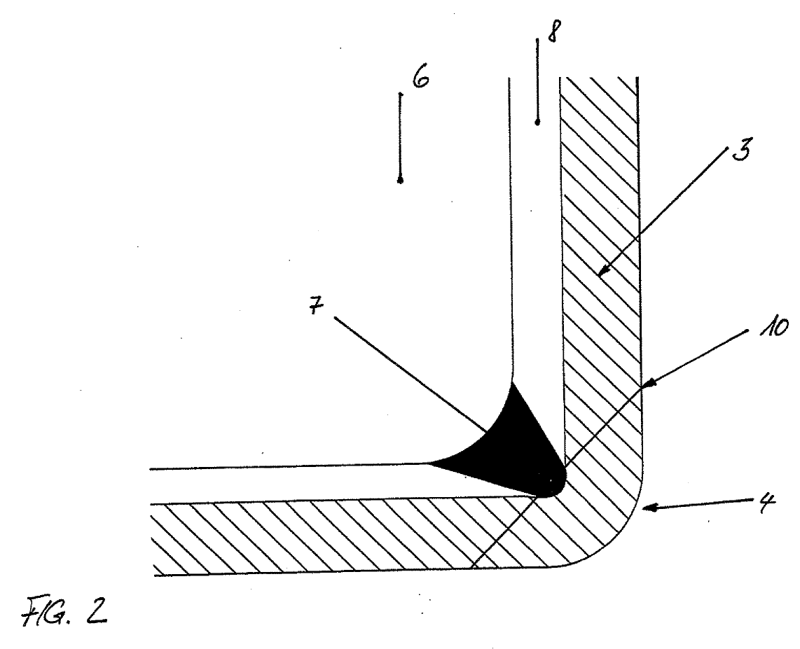

FIG. 2 shows, enlarged, the region 4 of the packaging according to FIG. 1.

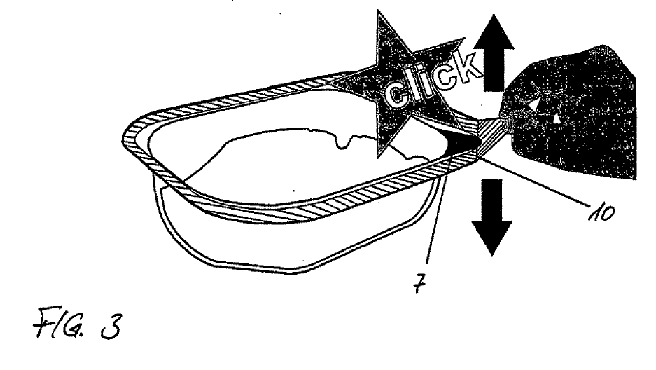

FIG. 3 shows the packaging according to the invention after bending along the weakening line in order to open the duct.

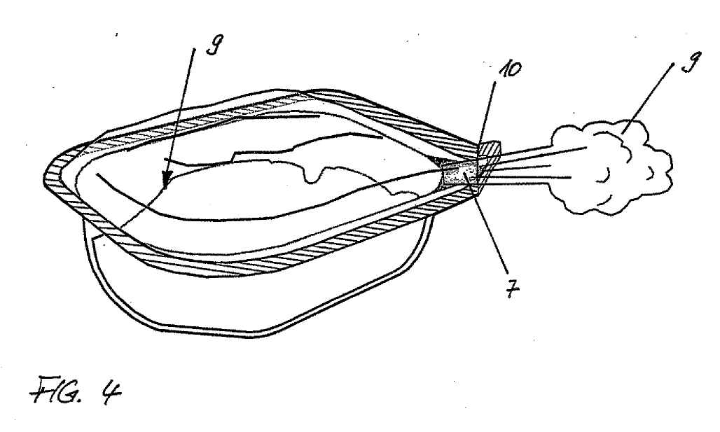

FIG. 4 shows the escape of the steam occurring as a result of heating the packaging through the opened duct.

FIG. 1 shows the packaging 1 according to the invention which has a packaging recess 2. This packaging recess is obtained by the deep-drawing of a planar underfilm sheet and has been filled with the packaged product 5. The closing film is sealed, here as a lid film 6, onto the margin 8 of the packaging recess 2 by means of the sealing seam 3, so that the packaging is closed so as to be gastight. In the region 4 of the packaging according to the invention, a duct 7 is formed into the margin 8 of the packaging recess, which duct extends from the inner boundary of the margin 8 of the packaging recess as far as the inner boundary of the sealing seam and is initially closed outwardly by the adjacent sealing seam. Furthermore, the packaging according to the invention has in the region of the duct, on the underside of the margin 8, an incision as a weakening line and predetermined bending point 10 which has been generated with the aid of a knife or with the aid of a laser.

The region 4 is illustrated in more detail in FIG. 2. The lid film 6 is sealed onto the outer part of the margin 8 of the packaging recess 2 along the entire region 4 by means of the sealing seam 3, so that, initially, no gas exchange with the surroundings can take place through the duct 7 which is closed by the adjacent sealing seam 3. In the region 4, a weakening line 10 is formed on the underside of the margin 8 and runs in a straight line through the sealing seam on both sides of the tip of the duct 7 in each case from the outer boundary of the margin 8 of the packaging recess and transversely to the longitudinal direction of the duct 7, preferably at a certain distance from the tip of the duct.

The opening of the duct 7 before heating is illustrated in FIG. 3. For this purpose, the margin of the packaging recess is to be grasped in the region 4 and is to be bent or pressed upward or downward, as a result of which a break of the margin 8 occurs along the weakening line 10 and the duct 7 is opened. Bending gives rise to a noise which is designated in FIG. 3 by “click”. Owing to this noise, the user recognizes that the packaging is not yet opened and, furthermore, the packaging has been opened sufficiently so that steam can escape during the heating of the contents.

The heating of the packaging according to the invention is illustrated in FIG. 4. During heating, steam 9 arises which can escape in the region 4, in particular through the opened duct 7. The packaging recess margin 8 bent upward during opening along the weakening line 10 thus allows the discharge of steam and prevents an unwanted bursting of the packaging on account of the steam overpressure occurring during heating.

### REFERENCE SYMBOLS

1 Packaging
2 Packaging recess
3 Sealing seam
4 Region of the packaging margin
5 Packaged product
6 Closing film
7 Duct
8 Margin of the packaging recess
9 Steam
10 Weakening line

1. A packaging suitable for exposure to microwaves, comprising a thermoformed packaging recess for holding a packaged product and a closing film, sealed onto a peripheral margin of the packaging recess along a sealing seam, the margin of the packaging recess having a region through which steam is capable of escaping during the heating of the packaged product, wherein both the packaging recess and the closing film is made essentially of thermoplastic material suitable for exposure to microwaves, and the margin of the packaging recess includes, in the region, a duct which extends from an inner boundary of the margin of the packaging recess as far as an inner boundary of the sealing seam and which is initially closed outwardly by the adjacent sealing seam and, has a weakening line as a predetermined breaking and/or predetermined bending point for the opening and for the escape of steam occurring during the heating of the packaged product.

2. A packaging suitable for exposure to microwaves as claimed in claim 1, wherein the duct) tapers in the direction of the sealing seam

3. A packaging suitable for exposure to microwaves as claimed in claim 1, wherein, wherein the sealing seam has a sealing seam strength of at least 4 N/25.4 mm.

4. The packaging suitable for exposure to microwaves as claimed in claim 1, wherein, wherein the weakening line runs transversely to the longitudinal direction of the duct.

5. The packaging suitable for pure to microwaves as claimed in wherein claim 1, wherein the region is arranged in a corner region of the packaging.

6. The packaging suitable for exposure to microwaves as claimed in claim 1, wherein the weakening line is formed in the region on the underside of the margin of the packaging recess as a predetermined breaking and/or predetermined bending point.

7. The packaging suitable for exposure to microwaves as claimed in claim 1, wherein the weakening line in the region is arranged such that at least the tip of the duct is opened under mechanical load on the weakening line, so that steam occurring in the packaging during the heating of the packaged product can escape outward.

8. The packaging suitable for pure to microwaves as claimed in claim 1, wherein the weakening line is arranged continuously transversely over the region of the duct, transversely over the sealing seam width or only in the region of the duct.

9. The packaging suitable for exposure to microwaves as claimed in claim 1, wherein the weakening line is arranged only in the sealing seam regions in each case adjacent to the duct.

10. The packaging suitable for exposure to microwaves as claimed in claim 1, wherein the weakening line is present as a continuous or discontinuous corresponding reduction in the film thickness of the margin of the packaging recess.

11. The packaging suitable for exposure to microwaves as claimed in claim 1, wherein the duct has been generated by thermoplastic forming.

12. The packaging suitable for exposure to microwaves as claimed in claim 1, wherein the weakening line has been generated by thermoplastic forming and/or mechanical action.

13. The packaging suitable for exposure to microwaves as claimed in claim 1, wherein the packaged product is a food which can be heated by the action of microwaves.

14. (canceled)

15. The method as claimed in claim 18, wherein the duct is opened, at least at its tip, by bending along the weakening line.

16. The method as claimed in claim 18, wherein the steam generated during the heating of the packaged product is cable of escaping through the opening of the duct.

17. The method as claimed in claim 18, wherein a noise is produced during bending along the weakening line.

18. A method for heating a packaging suitable for microwaves, as claimed in claim 1, comprising the steps of
bending the region of the packaging margin (8) along the weakening line (10) thereby opening a duct (7),
exposing the packaging to claim microwaves.
